(19) United States
(12) Patent Application Publication
(10) Pub. No.: US 2008/0121463 A1
(43) Pub. Date: May 29, 2008

(54) Escape installation

(76) Inventor: Yin-Hsi Liao, Tucheng City (TW)

Correspondence Address: TROXELL LAW OFFICE PLLC, SUITE 1404, 5205 LEESBURG PIKE, FALLS CHURCH, VA, 22041, US

(21) Appl. No.: 11/605,429

(22) Filed: Nov. 29, 2006

(51) Int. Cl. A62B 1/08

(52) U.S. Cl. 182/231

(57) ABSTRACT

An escaping installation includes a winding unit to wind and rewind a cable, and an escaping gear; a telescopic arm to allow the escaper keeping safe distance from the wall; the escaping gear includes a descender and a safety belt; the descender allows the escaper to descend at a reduced speed in conjunction with the cable adapted with a manual brake; the safety belt allows the escaper to fast wear the belt adapted to the descender to escape from the scene of disaster.

### BACKGROUND OF THE INVENTION

(a) Field of the Invention

The present invention is related to an escape installation, and more particularly to one essentially comprised of fastener and descender to allow a hi-rise escape route without being restricted to the hi-rise environment to safety reach the ground.

(b) Description of the Prior Art

Changed housing pattern due to social operation explains the formation of city jungle. The hi-rise also is also life threatening in case of a fire disaster, as it is very difficult for people to evacuate in time. Accordingly, an escape cable, rope, or equivalent is generally available to each building for people trapped in a burning building when safety ladder is blocked.

However, the life cable is usually adapted to an escape sling, or a descending device and the length of the escape sling is limited by the elevation of the building. In case of an accident, one has to hang the escape sling on a rack and tighten up the hook of the escape sling with screws, and make sure that the rack is firmly secured before throwing the rope to the floor below. The user then wears the strap attached to the other end of the rope under both armpits, pull a locking ring in front, have both hands holding the cable, jump out of the window facing the wall before letting go both hands to slowly descend to the ground relying upon an eccentric braking mechanism built in the escape sling.

While descending, one has to have both palms slightly contacting the wall to duck away any protruded object. As one reaches the ground, he/she has to quickly take off the strap for the next one to use. The prolonged gap of using the escape sling also accelerates the damage to the escape sling. Therefore, the escape sling may fail its purpose for saving life.

Furthermore, the escape sling usually has to be installed on a higher wall, which cannot be found to the roof deck or balcony of certain building, thus to rule out the installation of the escape sling. In case of a disaster, the power supply to the building will be usually cut off. The interrupted power supply will make it impossible for a power mechanism, if provided, to rewind the rope.

### SUMMARY OF THE INVENTION

The primary purpose of the present invention is to provide a hi-rise escaping installation comprised of a cable winding unit and is an escape mechanism. The winding unit includes a primary reel, and a secondary reel to rewind a cable; a telescopic arm separately provided for the escaper to keep a safe distance from the wall; a descender to reduce the descending speed and allow manual braking in conjunction with the escape cable; and a safety belt adapted to the descender to permit fast and safe landing.

### BRIEF DESCRIPTION OF THE DRAWINGS

FIG. 1 is a schematic view of the present invention in use.

FIG. 2 is a perspective view of a mainframe of the present invention.

FIG. 3 is a perspective view of a winding unit of a first preferred embodiment of the present invention.

FIG. 4 is another perspective view of the winding unit of the first preferred embodiment of the present invention.

FIG. 5 is a sectional view of the winding unit of the first preferred embodiment of the present invention.

FIG. 6 is a perspective view of a winding unit of a second preferred embodiment of the present invention.

FIG. 7 is another perspective view of the winding unit of the second preferred embodiment of the present invention.

FIG. 8 is a schematic view showing an operating status of the winding unit of the second preferred embodiment of the present invention.

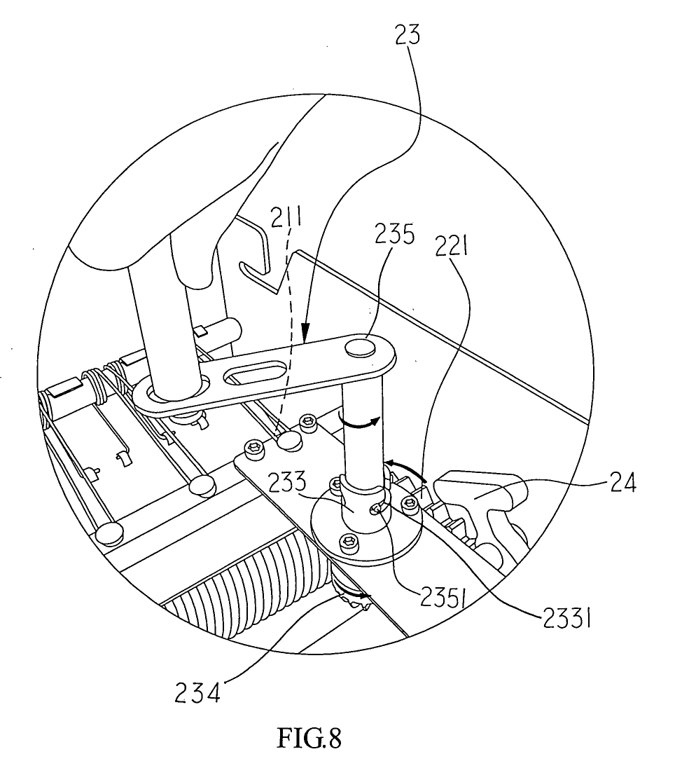

FIG. 9 is a schematic view showing an operating status of a descender of the present invention.

FIG. 10 is a perspective view of a stationary handle and a mobile handle of the present invention.

FIG. 11 is an exploded view of a guide pulley adapted to the descender of the present invention.

FIG. 12 is a schematic view showing an operating status of the guide pulley adapted to the descender of the present invention.

### DETAILED DESCRIPTION OF THE PREFERRED EMBODIMENTS

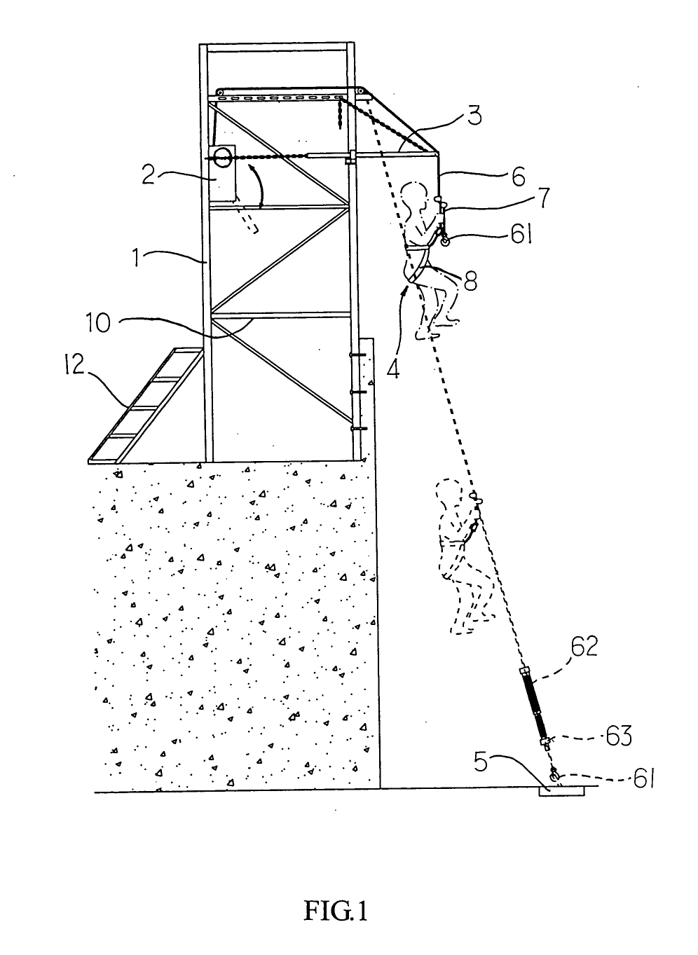

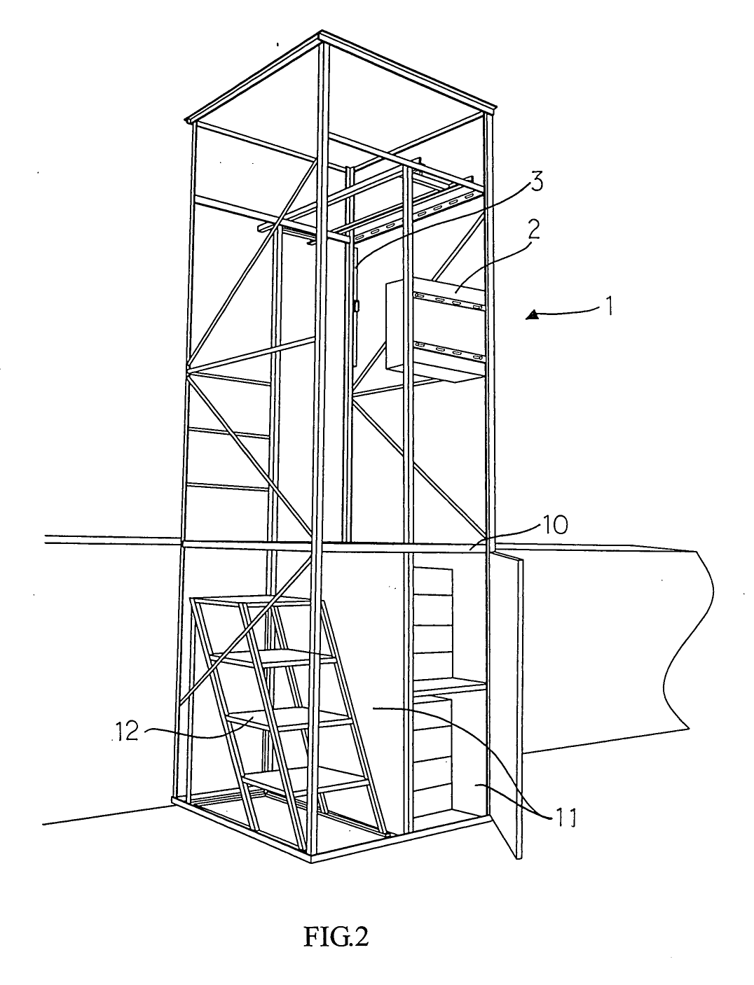

Referring to FIGS. 1 and 2 for a preferred embodiment of the present invention, an escaping installation includes a winding unit 2, and an escaping gear 4 provided on an escaping frame 1, and a telescopic arm 3 for an escaper to keep a safe distance from the wall.

The escaping frame 1 is built on the top floor or any other floor for the mounting of the winding unit 2, the telescopic arm 3, and the escaping gear 4; a deck 10 and a ladder 12 are disposed on the escaping frame 1 for the escaper to clime and stand; a space below the deck 10 stores the escaping gear 4 and the ladder 12; and the ladder 12 may be disposed to the outer or inner side of the deck 10.

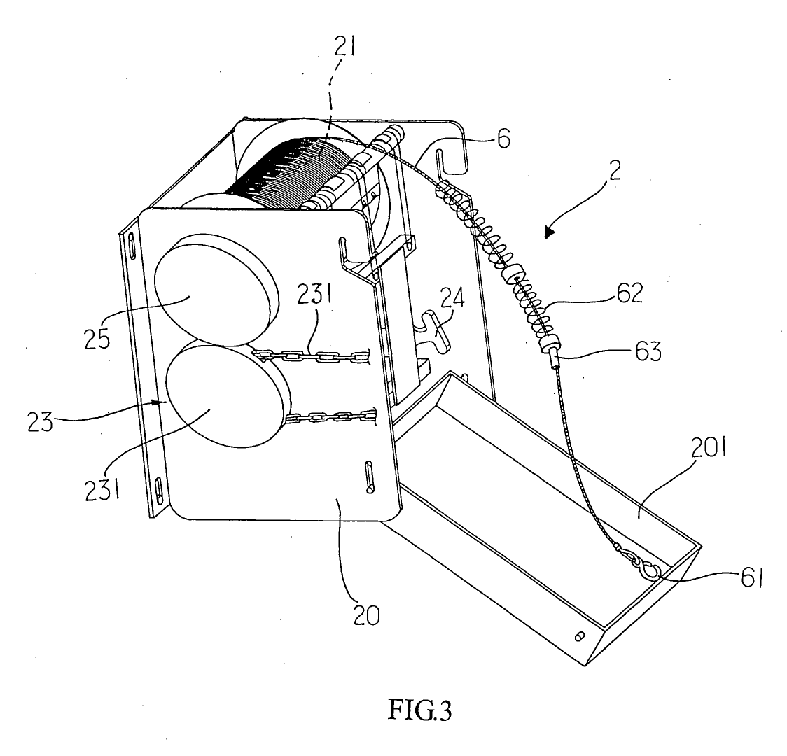

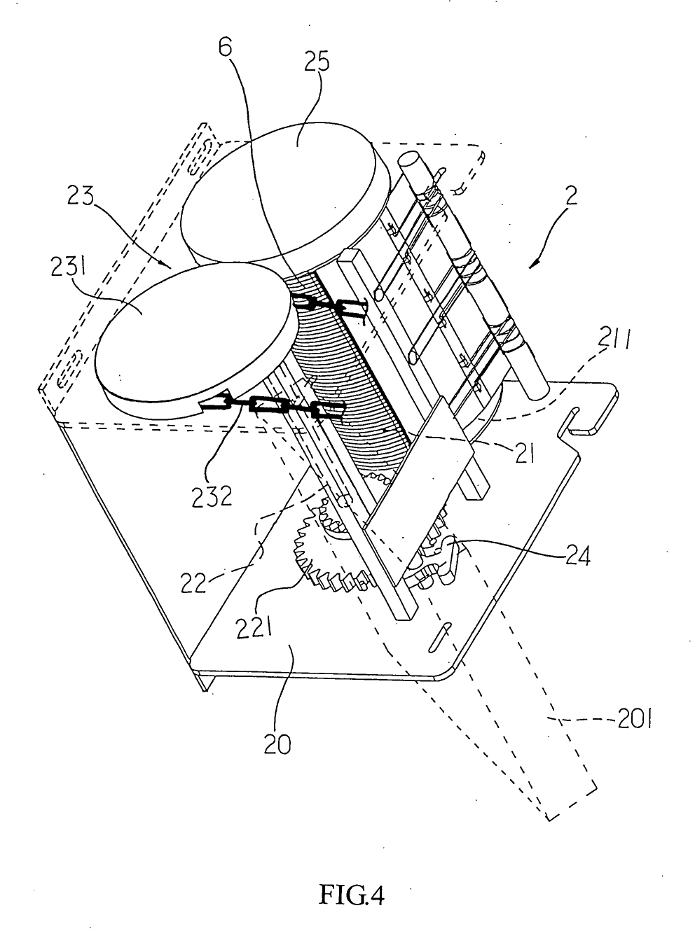

Now referred to FIGS. 3, 4, and 5, the winding unit 2 includes a mechanic body 20, a primary reel 21, a secondary reel 22, and a manual driver 23. The mechanic body 20 is provided for the assembly of associate members; the primary reel 21 is disposed to the mechanic body 20 by penetrating through both opposite walls of the mechanic body 20; the primary body 20 is capable of free rolling and is provided with a first gear wheel 211 to wind or rewind a cable 6; the secondary reel 22 next to the primary reel 21 is also disposed by penetrating both opposite walls of the mechanic body 20; the secondary reel 22 is also capable of free rolling and is provided with a second gear wheel 221; both of the first and the second gear wheels 211, 221 are intermeshed to each other to drive the primary reel 21 to revolve; the manual driver 23 is disposed to one site of and linked to the secondary reel 22 for transmission; and the manual driver 23 when operated manually drives the secondary reel 22 to revolve.

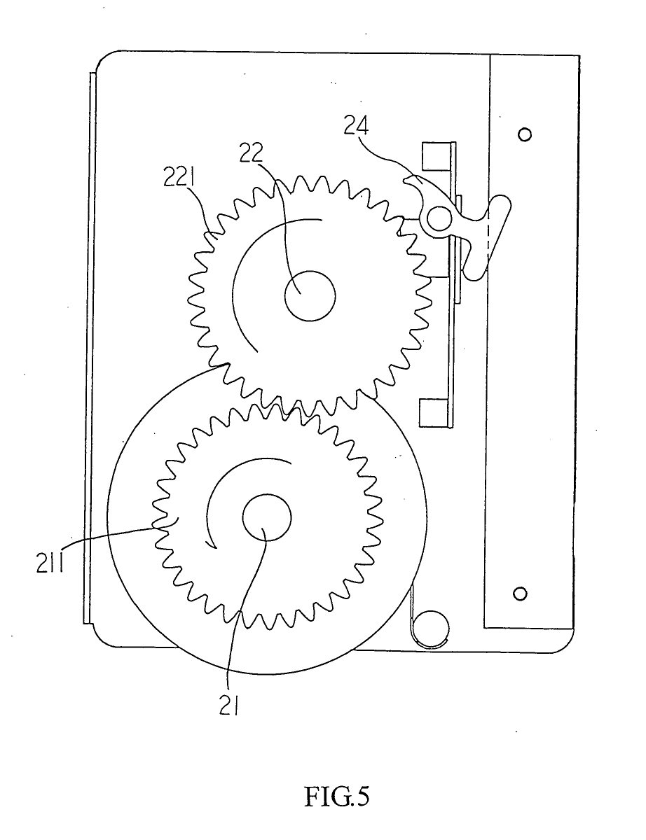

In the preferred embodiment, the manual driver 23 disposed to the end of the secondary reel 22 relates to a chain type cable winder 231. A chain 232 operates manually to drive the second gear wheel 221 of the secondary reel 22 to further drive the first gear wheel 211 of the primary reel 21 to revolver to wind a cable 6 and adjust the tension of the cable 6. As illustrated in FIG. 5, a one-way limit switch 24 is provided to the secondary reel 22 to control whether the secondary reel resolves or not. To release the cable, the one-way limit switch 24 is dialed to open for it to be relieved from the second gear wheel 221 and allow the cable 6 to descend to the ground to be incorporated with a locating ring set 5. To allow the chain type cable winder 231 for adjusting tension of the cable 6; the one-way limit switch 24 is dialed to the other way to engage the second gear wheel 221 so to force the secondary reel 22 to revolve only in one way. When the secondary reel 22 revolves as driven by the chain type cable winder 231, it is linked to the primary reel 21 to adjust the tension of the cable 6 or wind/rewind the cable 6 to provide an escape route by taking advantage of the drive linked to the first gear wheel 211 and the second gear wheel 221.

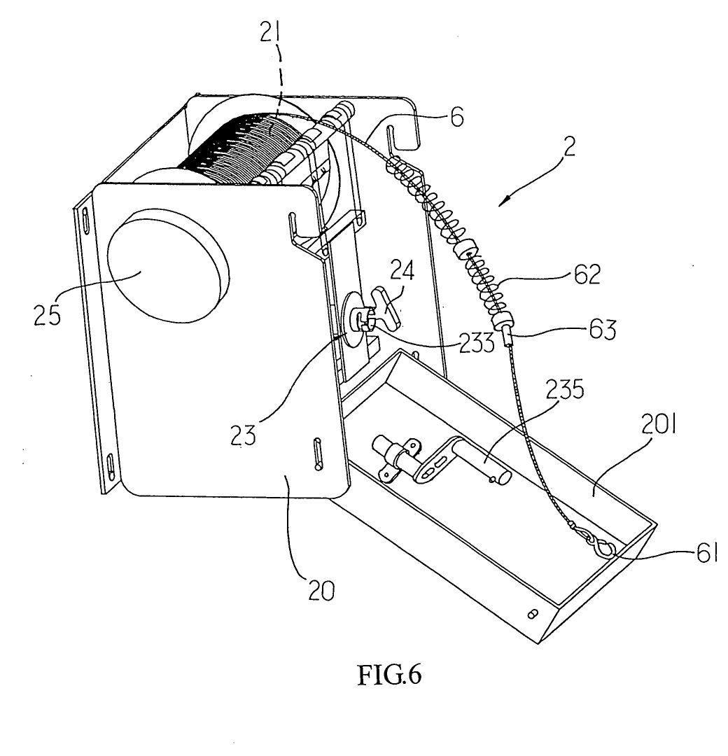

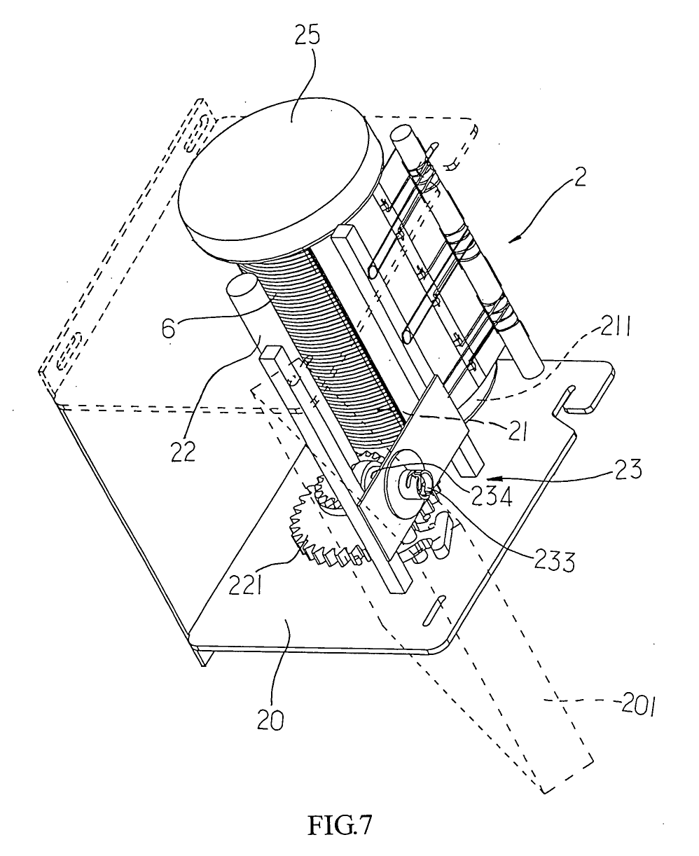

As illustrated in FIGS. 6, and 7 for another preferred embodiment of the present invention, an insertion holder 233 is disposed to the manual driver 23 at where appropriately on the second reel 22 to compromise the different location to mount the escape installation. One end of the insertion holder 233 is disposed with a wedged slot 2331 and the other end of the insertion holder 233 is disposed with a third gear wheel 234; the third gear wheel 234 from the insertion holder 233 is linked for motion to the second gear wheel 221 from the secondary reel 22.

In addition, a wire winding tool 235 is provided with one end disposed with a tenon 2351; and the tenon 2351 from the wire winding tool 235 is locked in the wedged slot 2331 of the insertion holder 233 for the user to have the wire winding tool 235 to drive the primary reel 221 and the cable 6 for achieving the same purpose of adjusting the tension of the cable 6 or winding/rewinding the cable 6.

The cable-winding unit 2 is further provided with an eccentric brake 25 at where the primary reel 21 is located. The eccentric brake 25 allows maintain a safe speed of the descending cable 6. As illustrated in FIGS. 3 and 6, a lid 201 is pivoted to the mechanic body 20 for protection of internal members and accommodation of the cable 6, the chain 231, the wire-winding tool 235, a buffer coil 62, and a height adjustment 63 under the lid 201 for storage purpose.

The escaping gear 4 includes a descender 7 and a safety belt 8. The descender 7 holds onto the cable 6. The cable 6 has at its terminal disposed with a hook 61, the buffer coil 62, and the height adjustment 63. The hook 61 buckles up the safety belt 8 worn by the escaper to control the descending speed of the cable 6 for a safe landing. After landing on the ground, the escaper fixes the hook 61 at the terminal of the cable 6 to the locating ring set 5 (as illustrated in FIG. 1). The buffer coil 62 operates to absorb the shock when the escaper is approaching the ground. The height adjustment 63 operates to adjust the landing height.

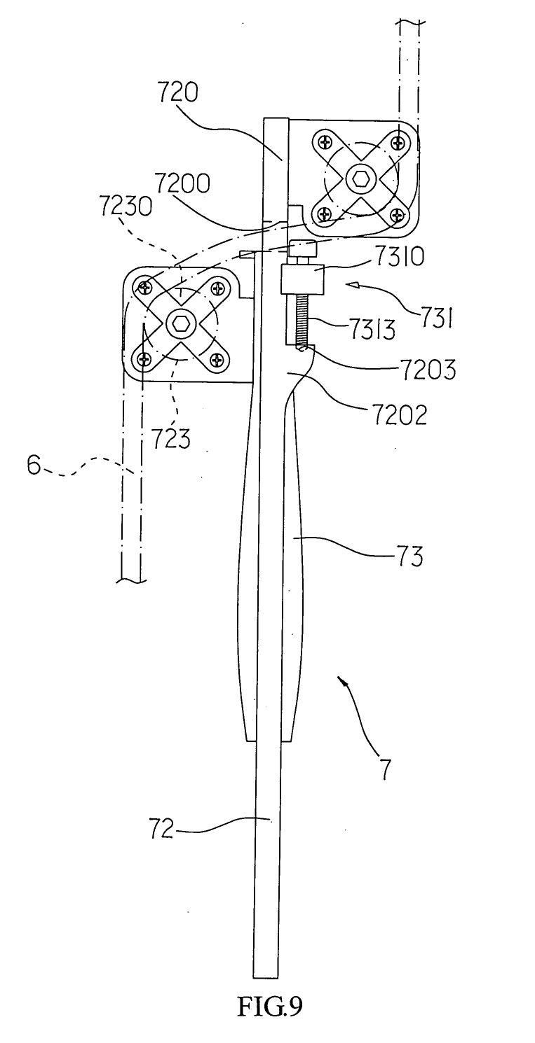

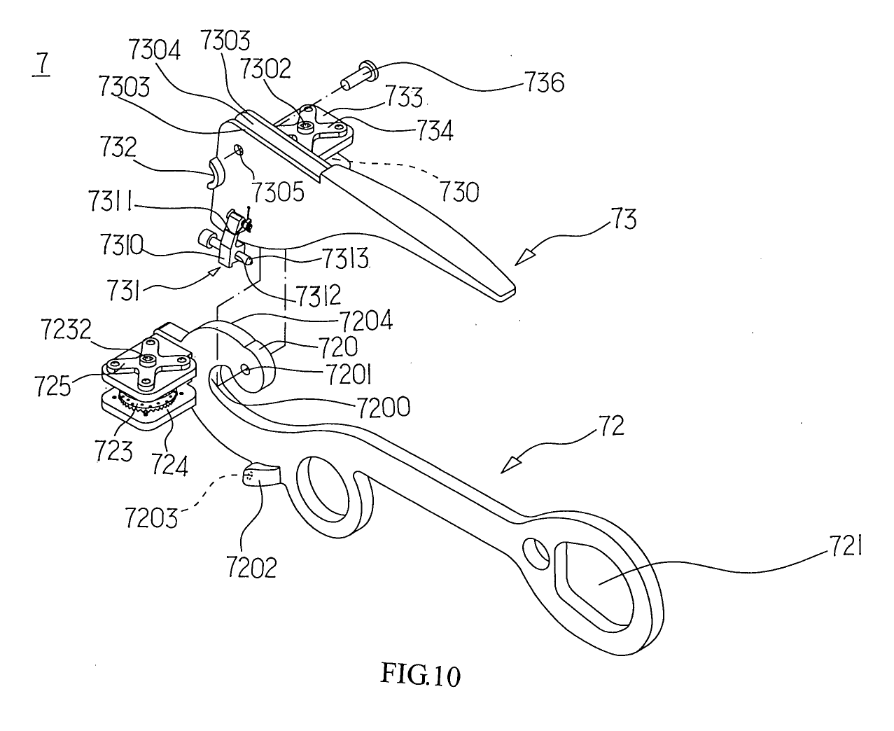

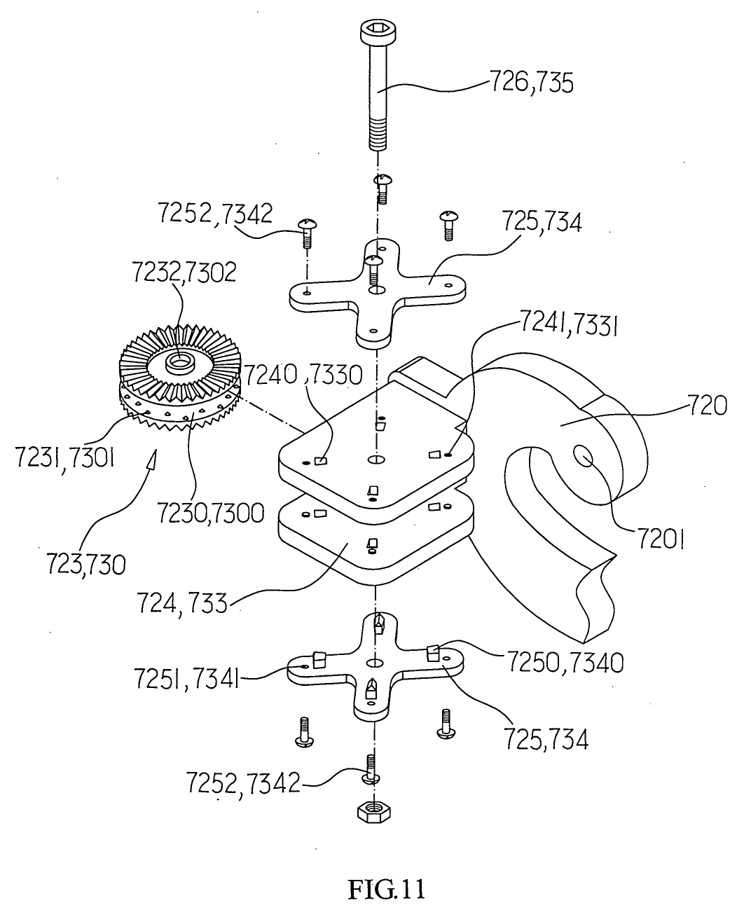

As illustrated in FIGS. 9 and 10, the descender includes a stationary handle 72 and a mobile handle 73. One end of the stationary handle 72 is disposed with a hook 720 and an inner diameter 7200 is defined on the inner side of the hook 720. On the other end of the stationary handle 72 is disposed with an eyelet 721 while a first guide pulley 723 engaging in free rotation is disposed on one side of the hook 720 from the stationary handle 72. As illustrated in FIG. 11, the outer circumference of the first guide pulley is toothed and multiple tapered dots 7231 protrude from the inner side 7230 of the first guide pulley 723.

The first guide pulley 723 is pivoted to a first guide pulley holder 724 and the latter indicates a [symbol] shaped section. One or a plurality of smooth hole 7240 and one or a plurality of threaded hole 7241 are respectively provided on both sides of the first guide pulley holder 724. Each of both sides of the first guide pulley holder 724 is disposed with a cross member 725. One or a plurality of tapered protrusion 7250 and one or a plurality of threaded hole 7251 are disposed on the cross member 725. The cross member 725 is locked with multiple bolts 7252 to the first guide pulley holder 724; and the first guide pulley 723 is locked with a bolt 726 to the first guide pulley holder 724. As illustrated in FIGS. 10 and 11, the first guide pulley holder 724 is fixed to one side of the stationary handle 72; and a first pivoting hole 7201 is disposed to the terminal of the hook 720 for pivoting the stationary handle 72 to the mobile handle 73. As illustrated in FIG. 9, a surface 7230 of the first guide pulley 723 is preferred to face where the inner diameter 7200 of the hook 720 to such that the cable 6 is able to bypass the first guide pulley 723 to forthwith pass through the inner diameter 7200 of the hook 720.

As illustrated in FIG. 10, one side of the mobile handle 73 pivoted to the stationary handle 72 is provided with a second guide pulley 730 and a locating device 731. The second guide pulley 730 is located at where opposite to the location of the first guide pulley 723. An arc concave 732 is formed on one end of the mobile handle 73, and the mobile handle 73 is movably pivoted to the stationary handle 73 so that both of the stationary handle 72 and the mobile handle 73 are cable of moving in relation to each other, thus for the end of the mobile handle 73 to close or open the hook 720 of the stationary handle 72. When the hook 720 is closed, the concave 732 and the inner diameter 7200 of the hook 720 merely hold onto a cable; and both of the mobile handle 73 and the stationary handle 72 are contained to each other and locked by means of the locating device 731. If and when necessarily, by firmly holding both of the stationary handle 72 and the mobile handle 73 to cause both of the inner diameter 7200 of the hook 720 and the concave 732 to tightly bite the a cable 74 for applying a hand braking.

As illustrated in FIG. 11, the second guide pulley 730 shares the same construction with that of the first guide pulley 723 and the outer circumference of the second guide pulley 730 is also toothed. Multiple tapered dots 7301 protrude from the inner side 7300 of the second guide pulley 730. The second guide pulley 730 is pivoted to a second guide pulley holder 733 and the latter indicates a [symbol] shaped section.

One or a plurality of smooth hole 7330 and one or a plurality of threaded hole 7331 are respectively provided on both sides of the second guide pulley holder 733. Each of both sides of the second guide pulley holder 733 is disposed with a cross member 734. One or a plurality of tapered protrusion 7340 and one or a plurality of threaded hole 7341 are disposed on the cross member 734. The cross member 734 is locked with multiple bolts 7342 to the second guide pulley holder 733; and the second guide pulley 730 is locked with a bolt 735 to the second guide pulley holder 7334. As illustrated in FIGS. 10, the second guide pulley holder 733 is fixed to one side of the mobile handle 73.

The locating device 731 includes a mobile latch 7310 pivoted to the mobile handle 73. The mobile latch 7310 is incorporated with a coil 7311 to compress the mobile latch 7310. A through hole 7312 containing a bolt 7313 is provided in the mobile latch 7310. A slope 7201 is formed on one side of the stationary handle 72 and a retaining portion 7203 is disposed at the top of the slope. The mobile latch 7310 contacts and moves along the slope to the retaining portion 7203 in the process of the relative movement between the mobile handle 73 and the stationary handle 72 for both of the mobile handle 73 and the stationary handle 72 to contain and lock up each other. As illustrated in FIG. 10, the through hole 7312 and the bolt 7313 may be fixed without allowing adjustment; or alternatively as illustrated in FIG. 9, both of the through hole 7312 and the bolt 7313 are threaded to engage each other for adjustment of the torque.

In the connection between the stationary handle 72 and the mobile handle 73 of the present invention as illustrated in FIG. 10, a side 7204 and a pivoting hole 7201 are disposed to the hook 720 of the stationary handle 72. One end of the mobile handle 73 is provided with a through hole 7305 and two side walls 7303 and a space 7304 is defined between both side walls 7303. In assembling, the side 7204 of the stationary handle 72 is inserted to the space 7304 between both inner walls 7303 of the mobile handle 73 to such that the pivoting hole 7201 at the end of the hook 720 aligns at the through hole 7305 provided on one side of the mobile handle 73; and a pivot 736 passes through the pivoting hole 7305 to rivet the through hole 7201.

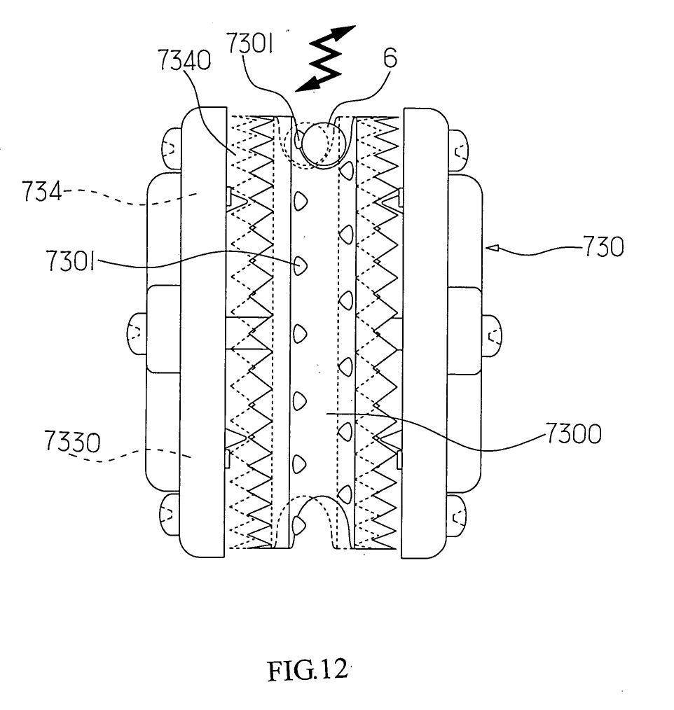

The outer circumference each of the first and the second guide pulleys 723, 730 are toothed. If the guide pulley illustrated in FIG. 12 relates to the second guide pulley 730, multiple tapered dots 7301 protrude from the inner surface 7300 of the second guide pulley 730, and the cross member 734 is fixed to the guide pulley holder 733, resistance is created due to friction between those protruding tapered dots 7340 from the cross member 734 and the toothed outer circumference of the guide pulley. When the cable 6 presses against the guide pulley, the guide pulley is forced by those multiple protruding tapered dots 7301 and the inner side 7300 to drive the guide pulley to rotate for producing resistance by friction. Accordingly, the escaper is prevented from getting injured due to excessive impacts upon landing.

The safety belt 8 is related to a sitting and adjustable, chest-wearing belt. To escape in case of a disaster, the escaper simply wears the pre-adjusted safety belt 8, has it in position to achieve the optimal straining status, and holding the descender 7 to reach the ground at a safe speed.

The telescopic arm 3 may be related to a telescopic rod provided for the escaper at a higher floor to facilitate smooth descending of the cable 6 by keeping the escaper to maintain a safe distance from the building.

The prevent invention provides an improved structure of a hi-rise escape installation, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. An escape installation including a cable winding unit disposed with a free rolling primary reel penetrating through two opposite walls of the winding unit; a first gear wheel disposed to the primary reel; a free rolling secondary reel disposed next to the primary reel also penetrating through two opposite walls of the winding unit; a second gear wheel disposed to the secondary reel and intermeshed with the first gear wheel wheel; an escaping gear including a safety belt; a descender including a stationary handle and a mobile handle pivoted to each other, one end of the stationary handle being provided with a hook and the other end being disposed with a buckling ring; a first guide pulley holder disposed to one side of the stationary handle and provided with a first guide pulley incorporated to the stationary handle; a second guide pulley holder disposed to one side of the mobile handle and provided with a second guide pulley incorporated to the mobile handle; and a locking device disposed to one side of the mobile handle to contain and lock up both of the stationary and the mobile handles.

2. A high-rise escaping installation as claimed in claim 1, wherein a manual driver to drive the secondary reel to revolve further provided the escaping installation to couple to the secondary reel for transmission is comprised of an insertion holder, a wire winder gear, and a chain cable winder provided with a chain.

3. A high-rise escaping installation as claimed in claim 1, wherein the installation is further provided with an escaping deck on the top floor or any other floor of a hi-rise for the assembly of associate escaping components; a telescopic arm for throwing the cable for the escaper to keep a safe distance from the wall; and a locating ring set disposed on the ground to link to the cable descending to the ground.

4. A high-rise escaping installation as claimed in claim 1, wherein an eccentric brake is disposed on one side of the primary reel for maintaining safety speed of the escaper or the cable upon descending.

5. A high-rise escaping installation as claimed in claim 1, wherein the outer circumference each of the primary guide pulley and the secondary guide pulley is toothed; a tapered protrusion is each provided to the first and the second guide pulley holders; and resistance is created by friction between the first guide pulley holder and its tapered protrusion as well as between the second guide pulley holder and its tapered protrusion to serve as a buffer mechanism to prevent the escaper from being hurt upon landing on the ground due to impact.

6. A high-rise escaping installation as claimed in claim 1, wherein a concave is formed on one end of the mobile handle; the mobile handle being connected to the stationary handle to engage relative rotation for the end of the mobile handle to close or open the hook; with the hook closed up, the concave and the inner diameter of the hook merely hold a cable; both of the mobile and the stationary handles are contained by each other and then locked up by the locking device; the locking device includes a mobile latch pivoted to one end of the mobile handle; the mobile latch is incorporated with a coil; the coil compresses against the mobile latch; a through hole is disposed to the mobile latch; a bolt is disposed in the through hole; a slope is defined on one side of the stationary handle; a retaining portion is disposed at the top of the slope; the mobile latch contacts and moves along the slope in the process of the relative movement between the mobile and the stationary handles.

7. A high-rise escaping installation as claimed in claim 1, wherein multiple tapered angles slightly protrude from the inner surface each of the first and the second guide pulleys.

8. A high-rise escaping installation as claimed in claim 1, wherein one or a plurality of smooth hole and one or a plurality of threaded hole are disposed to each of both sides of the pulley guide holder; both sides of the guide pulley holder are each disposed with a cross member; each cross member is disposed with one or a plurality of tapered protrusion and one or a plurality of threaded hole; multiple bolts lock the cross member to the guide pulley holder; and two bolts respectively locks up the first and the second guide pulleys to the first and the second pulley holders.
